(19) United States
(12) Patent Application Publication
(10) Pub. No.: US 2004/0105522 A1
(43) Pub. Date: Jun. 3, 2004

(54) Method of operating a nuclear power plant and a nuclear power plant

(76) Inventors: Willem Adriaan Odendaal Kriel, Centurion (ZA); Michael Christiaan Nieuwoudt, Centurion (ZA)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 10/473,192

(22) PCT Filed: Feb. 28, 2002
(86) PCT No.: PCT/IB02/00601

(30) Foreign Application Priority Data
Mar. 26, 2001 (ZA) 2001/2459

(51) Int. Cl. G21C 3/56; G21C 19/28

(52) U.S. Cl. 376/383

(57) ABSTRACT

A nuclear power plant which includes a closed loop power generation circuit making use of helium as the working fluid. The plant further includes a helium inventory control system which includes a plurality of helium storage tanks whereby helium can be fed into or removed from the power generation circuit. Each helium storage tank is provided with a heat sink so that the tank has a relatively high thermal inertia which in turn restricts the temperature variation within the storage tank as a result of the introduction of helium into and/or the withdrawal of helium from the storage tank. This permits the optimization of the design of the storage tanks.

THIS INVENTION relates to the generation of electricity. More particularly it relates to a method of operating a nuclear power plant and to a nuclear power plant. It also relates to a storage tank.

In a nuclear power plant making use of helium as a working fluid and having a nuclear reactor and power conversion system connected in a closed loop power generation circuit, the power generated is proportional to the mass flow rate of helium passing through the reactor core.

In order to permit the power generated to vary, use is made of a helium inventory control system configured to permit helium to be extracted from and introduced into the power generation circuit thereby permitting the helium inventory in the power generation circuit and hence the mass flow through the reactor to be adjusted.

According to one aspect of the invention there is provided a method of operating a nuclear power plant having a closed loop power generation circuit making use of helium as the working fluid and a helium inventory control system having at least one helium storage tank connectable in flow communication with the closed loop power generation circuit to permit helium to be introduced into and removed from the power generation circuit, which method includes the step of restricting the temperature variation within the at least one storage tank as a result of the introduction of helium into and the withdrawal of helium from the at least one storage tank.

The helium inventory control system typically includes a plurality of storage tanks, the pressure in which varies from a low pressure tank to a high pressure tank, the method then including restricting the temperature variation within each of the tanks.

Ideally, isothermal conditions are maintained within the or each storage tank since this permits optimization of the design of the storage tanks. This, however, is not practical and it is therefore desirable to maintain conditions within the tanks as close to isothermal as possible in a cost effective manner. The method may include restricting the temperature variation within the or each storage tank due to helium being introduced into or removed from the storage tank to 20° C.

Restricting the temperature variation may be achieved passively. To this end the method may include providing in the or each tank a heat sink.

According to another aspect of the invention there is provided a nuclear power plant which includes

a closed loop power generation circuit making use of helium as the working fluid; and

a helium inventory control system which includes at least one helium storage tank connectable in flow communication with the power generation circuit to permit helium to be introduced into and removed from the power generation circuit, and means for restricting the temperature variation within the at least one storage tank as a result of the introduction of helium into and the withdrawal of helium from the at least one storage tank.

The helium inventory control system may include a plurality of helium storage tanks and means for restricting the temperature variation in each of the tanks.

The plant may include a high pressure connection point and a low pressure connection point whereby the helium inventory control system is selectively connectable to the power generation circuit.

This arrangement permits helium to be extracted from the high pressure point and introduced into the power generation circuit at the low pressure point without the need for external compressors.

The power generation circuit may use a modified Brayton cycle as the thermodynamic conversion cycle. The power generation circuit may include two single-shaft turbine/compressor sets and one power turbine with a directly coupled electricity generator, a pre-cooler and inter-cooler positioned respectively between a hot or low pressure side of a counterflow recuperator and the low pressure compressor and between the low pressure compressor and the high pressure compressor.

Restricting the temperature variation in the helium storage tanks may be achieved passively. To this end, each tank may be designed to have a high thermal inertia. This is achieved by providing a heat sink in the or each tank.

Naturally, the heat sink may vary depending on requirements and fabrication limitations.

The heat sink may be of steel and have a mass of between 180 kg and 300 kg per cubic meter of storage capacity of the storage tank in which it is positioned.

The heat sink may have a surface area for heat transfer of between 400 and 500 m² per cubic meter of storage capacity of the storage tank.

The heat sink may include a plurality of plates, the spacing between which is between 25 and 40 times the plate thickness.

According to another aspect of the invention there is provided a storage tank suitable for use in a helium inventory control system of a nuclear power plant, which tank includes

a vessel; and

at least one heat sink positioned in the vessel.

The heat sink may have a heat capacitance of between 80 kJ/K and 140 kJ/K per cubic meter of storage capacity of the vessel.

The heat sink may be of steel and have a mass of between 180 kg and 300 kg per cubic meter of storage capacity of the vessel.

The heat sink may have a surface area of between 400 m² and 500 m² per cubic meter of storage capacity of the vessel.

The vessel may have a storage capacity of 100 m³ and the heat sink may be of steel and have a mass of 30000 kg and a surface area of between 40000 and 50000 m².

The heat sink may be of aluminium and have a mass of between 90 kg and 150 kg per cubic meter of storage capacity of the vessel.

The heat sink may be formed from sheet material which has a plurality of dimples thereon, each dimple having a height which is between 20 to 40 times the thickness of the sheet material.

The heat sink may comprise a plurality of parallel sheets of material, the dimples serving to space adjacent sheets one from another and thereby facilitate the flow of helium between the sheets.

The heat sink may be in the form of sheet metal formed into a spiral.

The metal sheet may have a plurality of dimples thereon.

The height of each dimple may be between 20 and 40 times the thickness of the metal sheet.

The material may have a thickness of between 0.1 and 0.3 mm.

The heat sink may include a plurality of tubular elements.

The heat sink may be formed of wire mesh.

The invention will now be described, by way of example, with reference to the accompanying diagrammatic drawings.

In the drawings,

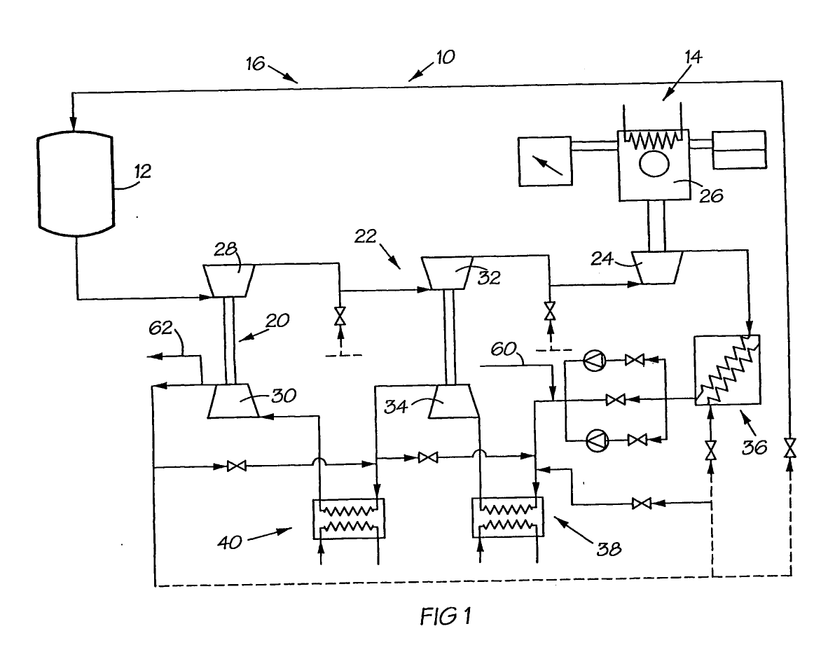

FIG. 1 shows a schematic representation of part of a nuclear power plant in accordance with the invention;

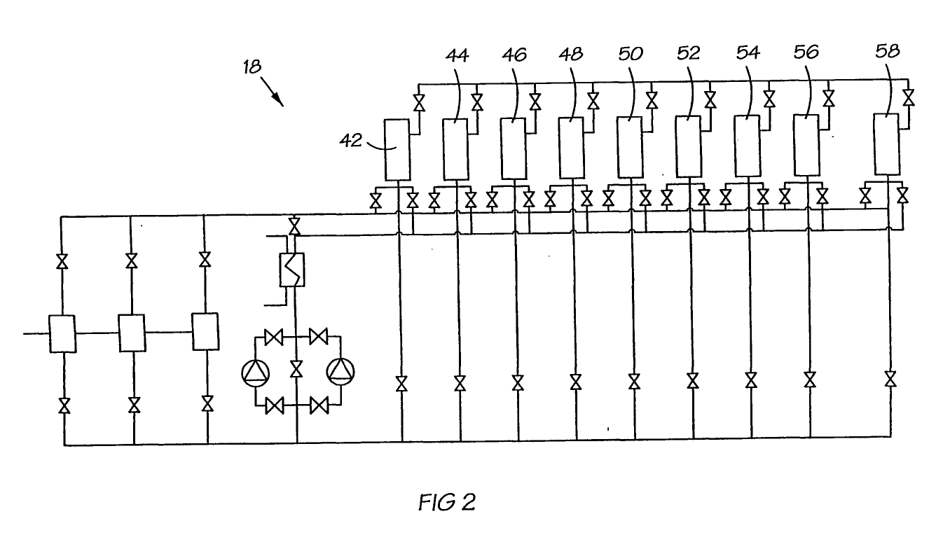

FIG. 2 shows a schematic representation of a helium inventory control system forming part of a nuclear power plant in accordance with the invention;

FIG. 3 shows a schematic sectional elevation of part of a storage tank of a helium inventory control system in accordance with the invention;

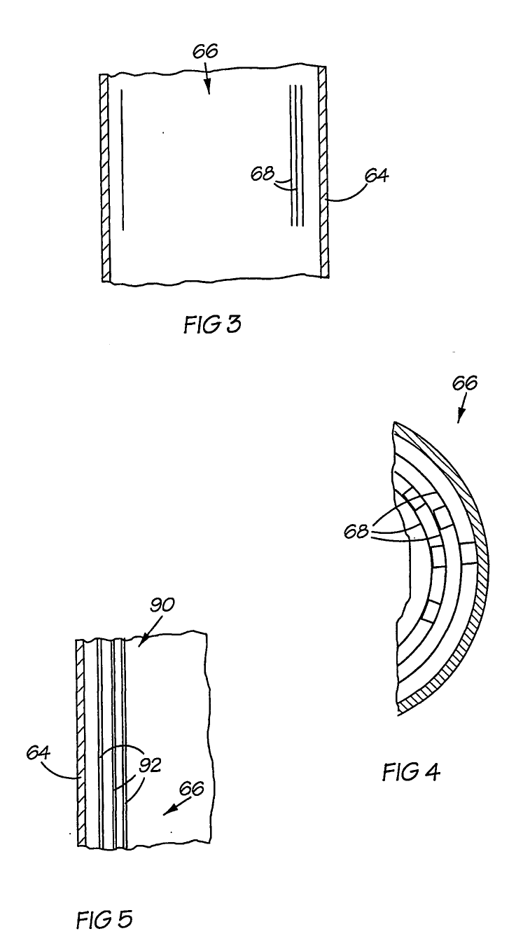

FIG. 4 shows, on an enlarged scale, a schematic transverse sectional elevation through another storage tank in accordance with the invention; and

FIG. 5 shows a sectional elevation through part of yet another storage tank in accordance with the invention.

In FIG. 1 of the drawings, reference numeral 10 refers generally to part of a nuclear power plant in accordance with the invention. The plant 10 includes a nuclear reactor 12 and a power conversion system, generally indicated by reference numeral 14 connected together in a closed loop power generation circuit, generally indicated by reference numeral 16.

With reference now also to FIG. 2 of the drawings, the nuclear power plant 10 includes a helium inventory control system, generally indicated by reference numeral 18 which is selectively connectable to and disconnectable from the power generation circuit 16 as described in more detail herebelow.

The power generation circuit 16 includes a high pressure single shaft turbine compressor set 20, a low pressure single shaft turbine compressor set 22 and a power turbine 24 drivingly connected to an electricity generator 26.

The high pressure turbine compressor set 20 includes a high pressure turbine 28 drivingly connected to a high pressure compressor 30. Similarly, the low pressure turbine compressor set 22 includes a low pressure turbine 32 drivingly connected to a low pressure compressor 34.

The power generation circuit 16 further includes a counter flow recuperator 36, a pre-cooler 38 and an inter-cooler 40. The pre-cooler 38 is positioned between a hot or low pressure side of the recuperator 36 and the low pressure compressor 34. The inter-cooler 40 is positioned between the low pressure compressor 34 and the high pressure compressor 30.

The helium inventory control system 18 includes eight storage tanks 42 through to 56 and a booster tank 58.

The pressure in the tanks 42 to 56 varies with the lowest pressure being in the tank 42 and the highest pressure being in the tank 56 and a range of 10 intermediate pressures in the tanks 44 to 54.

When it is desired to inject helium into the power generation circuit 16, helium is fed from the tank with the lowest pressure into the power generation circuit 16 at a low pressure injection point, indicated by reference numeral 60 in FIG. 1. When helium is to be extracted from the power generation circuit 16, it is extracted from a high pressure extraction point, indicated by reference numeral 62 in FIG. 1, and is fed into the tank with the highest pressure which has capacity to receive the helium.

Referring now to FIG. 3 of the drawings, each tank 42 to 58 includes a vessel 64 and a heat sink 66 positioned in the vessel 64.

The heat sink 66 is configured to have a sufficiently high thermal inertia so that irrespective of whether or not helium is being introduced into or removed from the tank, the temperature variation is relatively small, ie the maximum temperature variation does not exceed 20° C., so that generally isothermal conditions prevail within the tank.

In FIG. 3 of the drawings, the heat sink 66 comprises a plurality of relatively thin parallel plates 68 arranged in a grid. Dimples on the plates serve to space them apart and permit the flow of helium therebetween.

The plates typically have a thickness of between 0.1 and 0.3 mm and the spacing between the plates is typically between 25 to 40 times the plate thickness. In this regard the inventors believe that plates having a thickness of less than about 0.1 mm will be difficult to work with. Further plates having a thickness of greater than 0.3 mm will have a reduced surface area per unit mass thereby decreasing the efficiency of the heat transfer between the heat sink and the helium. The spacing between the plates will typically be selected to provide an even distribution of the plates throughout the vessel 64.

Naturally, the thermal inertia of the heat sink 66 will vary depending upon the size of the tank. However, in a tank having a storage capacity of about 100 cubic metres, the heat sink 66, when manufactured from steel, will have a mass of about 30000 kg and a surface area of between 40000 to 50000 m². If the heat sink is manufactured from aluminium the heat sink will have a mass of about 15000 kg and a surface area of between 40000 m² and 50000 m².

Naturally, the configuration of the heat sink 66 can vary. Hence, for example, in FIG. 4 of the drawings, reference numeral 80 refers generally to part of another tank in accordance with the invention and, unless otherwise indicated, the same reference numerals used above are used to designate similar parts. In this embodiment, the heat sink 66 is typically in the form of a spiral roll. Once again, when the tank has a storage capacity of about 100 m³, the heat sink may be formed from a sheet of metal 68 typically having a width of about 9.5 m and a thickness of between 0.1 to 0.3 mm with dimples of approximately 20 to 40 times the plate thickness provided thereon. The spiral is formed by forming the sheet metal into a roll which is generally circular in cross-section. In another embodiment, the roll may be generally square in cross-section. The dimples on the metal sheet serve to space adjacent layers of the sheet apart. One or more of these heat sinks 66 can be placed axially in a vessel 64 of a storage tank. Instead of using sheet material the heat sink 66 could be formed of wire mesh.

Similarly, in FIG. 5 of the drawings, reference numeral 90 refers generally to part of another tank in accordance with the invention and, unless otherwise indicated, the same reference numerals used above are used to designate similar parts.

In this embodiment of the invention, the heat sink 66 is formed from a plurality of tubes 92. Typically the tubes 92 are arranged in an axial direction within the vessel 64.

The Inventors believe that by restricting the temperature variation within the tanks, the storage volume required in order to store sufficient helium to satisfy the operating conditions of the nuclear power plant can be minimised.

1. A method of operating a nuclear power plant having a closed loop power generation circuit making use of helium as the working fluid and a helium inventory control system having at least one helium storage tank connectable in flow communication with the closed loop power generation circuit to permit helium to be introduced into and removed from the power generation circuit, which method includes the step of restricting the temperature variation within the at least one storage tank as a result of the introduction of helium into and the withdrawal of helium from the at least one storage tank.

2. A method as claimed in claim 1, in which the helium inventory control system includes a plurality of storage tanks, the pressure in which varies from a low pressure tank to a high pressure tank, the method including restricting the temperature variation within each of the tanks.

3. A method as claimed in claim 1 or claim 2, which includes restricting the maximum temperature variation within the or each storage tank due to helium being introduced into or removed from the storage tank to 20° C.

4. A method as claimed in any one of the preceding claims, in which rectricting the temperature variation is achieved passively.

5. A method as claimed in claim 4, which includes providing in the or each tank a heat sink.

6. A nuclear power plant which includes
a closed loop power generation circuit making use of helium as the working fluid; and
a helium inventory control system which includes at least one helium storage tank connectable in flow communication with the power generation circuit to permit helium to be introduced into and removed from the power generation circuit, and means for restricting the temperature variation within the at least one storage tank as a result of the introduction of helium into and the withdrawal of helium from the at least one storage tank.

7. A nuclear power plant as claimed in claim 6, in which the helium inventory control system includes a plurality of helium storage tanks and means for restricting the temperature variation in each of the tanks.

8. A nuclear power plant as claimed in claim 6 or claim 7, which includes a high pressure connection point and a low pressure connection point whereby the helium inventory control system is selectively connectable to the power generation circuit.

9. A nuclear power plant as claimed in any one of claims 6 to 8 inclusive, in which the or each tank is designed to have a high thermal inertia.

10. A nuclear power plant as claimed in claim 9, in which the high thermal inertia is achieved by providing a heat sink in the or each tank.

11. A nuclear power plant as claimed in claim 10, in which the heat sink is of steel and has a mass of between 180 kg and 300 kg per cubic meter of storage capacity of the storage tank in which it is positioned.

12. A nuclear power plant as claimed in claim 10 or claim 11, in which the heat sink has a surface area for heat transfer of between 400 and 500 m² per cubic meter of storage capacity of the storage tank.

13. A nuclear power plant as claimed in any one of claims 10 to 12 inclusive, in which the heat sink includes a plurality of plates, the spacing between which is between 25 and 40 times the plate thickness.

14. A storage tank suitable for use in a helium inventory control system of a nuclear power plant, which tank includes
a vessel; and
at least one heat sink positioned in the vessel.

15. A storage tank as claimed in claim 14, in which the heat sink has a heat capacitance of between 80 kJ/K and 140 kJ/K per cubic meter of storage capacity of the vessel.

16. A storage tank as claimed in claim 14 or claim 15 in which the heat sink is of steel and has a mass of between 180 kg and 300 kg per cubic meter of storage capacity of the vessel.

17. A storage tank as claimed in any one of claims 14 to 16, inclusive, in which the heat sink has a surface area of between 400 m² and 500 m² per cubic meter of storage capacity of the vessel.

18. A storage tank as claimed in any one of claims 14 to 17, inclusive, in which the vessel has a storage capacity of 100 m³ and the heat sink, is of steel has a mass of 30000 kg and a surface area of between 40000 and 50000 m².

19. A storage tank as claimed in claim 14, in which the heat sink is of aluminium and has a mass of between 90 kg and 150 kg per cubic meter of storage capacity of the vessel.

20. A storage tank as claimed in any one of claims 14 to 19, inclusive, in which the heat sink is formed from sheet material which has a plurality of dimples thereon, each dimple having a height which is between 20 to 40 times the thickness of the sheet material.

21. A storage tank as claimed in claim 20, in which the heat sink comprises a plurality of parallel sheets of material, the dimples serving to space adjacent sheets one from another.

22. A storage tank as claimed in any one of claims 14 to 19, inclusive, in which the heat sink is in the form of sheet metal formed into a spiral.

23. A storage tank as claimed in claim 22, in which the metal sheet has a plurality of dimples thereon.

24. A storage tank as claimed in claim 23, in which the height of each dimple is between 20 and 40 times the thickness of the metal sheet.

25. A storage tank as claimed in any one of claims 20 to 24, inclusive, in which the material has a thickness of between 0.1 and 0.3 mm.

26. A storage tank as claimed in claim 14, in which the heat sink includes a plurality of tubular elements.

27. A storage tank as claimed in claim 14, in which the heat sink is formed of wire mesh.

28. A method as claimed in claim 1 substantially as described and illustrated herein.

29. A nuclear power plant as claimed in claim 6 substantially as described and illustrated herein.

30. A storage tank as claimed in claim 14 substantially as described and illustrated herein.

31. A new method, plant or tank substantially as described herein.
